(19) United States
(12) Patent Application Publication
(10) Pub. No.: US 2026/0320307 A1
(43) Pub. Date: Oct. 15, 2026

(54) INFORMATION PROCESSING SYSTEM AND INFORMATION PROCESSING METHOD

(71) Applicant: SEMICONDUCTOR ENERGY LABORATORY CO., LTD., Atsugi-shi (JP)

(72) Inventors: Junpei MOMO, Sagamihara (JP); Hiroki HOSOSHIMA, Atsugi (JP); Aoi NAKAMURA, Atsugi (JP)

(21) Appl. No.: 19/463,256

(22) Filed: Jan. 29, 2026

(30) Foreign Application Priority Data
Feb. 14, 2025 (JP) 2025-022005

(51) Int. Cl. G06F 40/40; G06F 16/332

(52) U.S. Cl. CPC G06F 40/40; G06F 16/332

(57) ABSTRACT

A novel information processing system that is highly convenient, useful, or reliable is provided. The information processing system includes three components. The first component receives a document and transmits the document to the third component, and receives a message and provides the message. The second component receives a prompt, generates a description or an evaluation, and performs processing with a large language model. The third component receives and shares the document, the description, and the evaluation, creates the prompt, and transmits the prompt to the second component. In addition, the third component receives the message and transmits the message to the first component. The third component includes a subcomponent that performs processing with a database and a management system, a subcomponent that creates the prompt, and a subcomponent that creates the message on the basis of the evaluation.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include an information processing device, a semiconductor device, a memory device, a method for driving any of these devices, and a method for manufacturing any of these devices.

### 2. Description of the Related Art

In recent years, language models using neural networks have been actively developed, and especially large language models (LLM) have attracted attention. A large language model is a natural language processing model trained using a large amount of data. With a large language model, for example, an interactive model that gives an answer to a user's instruction can be achieved. In Non-Patent Document 1, Generative Pre-trained Transformer 4 (GPT-4, registered trademark) is disclosed as a large language model, and ChatGPT is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object of one embodiment of the present invention is to provide a novel information processing method that is highly convenient, useful, or reliable. Another object of one embodiment of the present invention is to provide a novel information processing system, a novel information processing method, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.

(1) One embodiment of the present invention is an information processing system including a first component, a second component, and a third component.

The first component is configured to receive a document and transmit the document to the third component and to receive a message and provide the message.

The second component is configured to receive a first prompt and a second prompt and transmit a description and an evaluation to the third component and to perform processing with a large language model.

The third component is configured to receive the document and the description and transmit the first prompt and the second prompt to the second component and to receive the evaluation and transmit the message to the first component.

The first prompt includes a first instruction and the document, and the first instruction includes a procedure for extracting the description indicated as a fact from the document. The second prompt includes a second instruction, the description, and public information, and the second instruction includes a procedure for generating the evaluation. The evaluation expresses consistency between the public information and the description.

(2) One embodiment of the present invention is an information processing system including a first component, a second component, and a third component.

The first component is configured to receive a first document and transmit the first document to the third component and to receive a message and provide the message.

The second component is configured to receive a first prompt and a second prompt and transmit a first description and a first evaluation to the third component and to perform processing with a large language model. Note that the large language model is configured to generate the first description in accordance with the first prompt and to generate the first evaluation in accordance with the second prompt.

The third component is configured to: receive the first document, the first description, and the first evaluation and share the first document, the first description, and the first evaluation inside the third component; create the first prompt and the second prompt and transmit the first prompt and the second prompt to the second component; and create the message and transmit the message to the first component. Furthermore, the third component includes a first subcomponent, a second subcomponent, and a third subcomponent.

The first subcomponent is configured to perform processing with a database and a management system and to obtain public information and share the public information inside the third component. The database is configured to store a public information group, and the management system is configured to obtain the public information from the public information group in accordance with a first query.

The second subcomponent is configured to create the first prompt, the first query, and the second prompt. The first prompt includes a first instruction and the first document, and the first instruction includes a procedure for extracting the first description indicated as a fact from the first document. The first query includes a request to collect information including the first description from the public information group. The second prompt includes a second instruction, the first description, and the public information, the second instruction includes a procedure for generating the first evaluation, and the first evaluation expresses consistency between the public information and the first description.

The third subcomponent is configured to create the message on the basis of the first evaluation.

With this structure, consistency between the first description indicated as a fact in the first document and the public information can be evaluated. When the first evaluation is lower than a set evaluation, a warning message can be provided to a user of the information processing system, for example. A disclosure by another person of a matter regarding the user of the information processing system or a corporation the user belongs to that is not a fact or has not been made public can be picked out. As a result, a novel information processing system that is highly convenient, useful, or reliable can be provided.

(3) One embodiment of the present invention is the above-described information processing system, in which the second component is configured to receive a third prompt and transmit a second evaluation to the third component and the large language model is configured to generate the second evaluation in accordance with the third prompt.

The third component is configured to receive the second evaluation and share the second evaluation inside the third component and to create the third prompt and transmit the third prompt to the second component. The database is configured to store a business information group, and the management system is configured to obtain business information from the business information group in accordance with a second query and share the business information inside the third component.

The second subcomponent is configured to create the second query and the third prompt. The second query includes a request to collect information including the first description from the business information group. The third prompt includes a third instruction, the first description, and the business information; the third instruction includes a procedure for generating the second evaluation; and the second evaluation expresses consistency between the business information and the first description.

The third subcomponent is configured to create the message on the basis of the second evaluation.

With this structure, consistency between the first description indicated as a fact in the first document and the business information can be evaluated. As a result, a novel information processing system that is highly convenient, useful, or reliable can be provided.

(4) One embodiment of the present invention is the above-described information processing system, in which when the first evaluation is lower than a set evaluation and the second evaluation is higher than the set evaluation, the message reports that the first description includes information that is not included in the public information group but included in the business information group.

With this structure, whether the first document indicates undisclosed information as a fact can be evaluated. Furthermore, the first document that indicates undisclosed information as a fact can be found and a message can be provided to the user of the information processing system, for example. As a result, a novel information processing system that is highly convenient, useful, or reliable can be provided.

(5) One embodiment of the present invention is the above-described information processing system, in which the second component is configured to receive a fourth prompt and transmit a type to the third component and the large language model is configured to classify the first description into the type in accordance with the fourth prompt.

The third component is configured to transmit the fourth prompt to the second component and to receive the type and share the type inside the third component.

The second subcomponent is configured to create the fourth prompt. The fourth prompt includes a fourth instruction and the first description, and the fourth instruction includes a procedure for classifying the first description into the type.

With this structure, the first description indicated as a fact in the first document can be classified into the type. As a result, a novel information processing system that is highly convenient, useful, or reliable can be provided.

(6) One embodiment of the present invention is the above-described information processing system, in which the second component is configured to receive a fifth prompt and transmit a first reference to the third component and the large language model is configured to identify the first reference in accordance with the fifth prompt.

The third component is configured to transmit the fifth prompt to the second component and to receive the first reference and share the first reference inside the third component.

The second subcomponent is configured to create the fifth prompt. The fifth prompt includes a fifth instruction, the first description, and the first document, and the fifth instruction includes a procedure for extracting the first reference of the first description from the first document.

With this structure, the first reference of the first description indicated as a fact in the first document can be extracted from the first document. As a result, a novel information processing system that is highly convenient, useful, or reliable can be provided.

(7) One embodiment of the present invention is the above-described information processing system, in which the database is configured to store a knowledge graph and the knowledge graph includes a first node and a second node.

The first subcomponent is configured to create the first node and the second node. Each of the first node and the second node includes a first label, and the first label is added to a node storing a description indicated as a fact.

The first node includes a first attribute value pair capable of storing a second description, a second attribute value pair capable of storing the type, a third attribute value pair capable of storing information that identifies a second document, and a fourth attribute value pair capable of storing information that identifies a second reference. The second description is a description indicated as a fact in the second document included in the public information group, and the second reference is a reference of the second description written in the second document.

The second node includes the first label, the first attribute value pair capable of storing the first description, the second attribute value pair capable of storing the type, the third attribute value pair capable of storing information that identifies the first document, and the fourth attribute value pair capable of storing information that identifies the first reference.

With this structure, the second description indicated as a fact in the second document included in the public information group and the first description indicated as a fact in the first document can be expressed in the knowledge graph. For example, in the case where the second document included in the public information group includes the second description indicated as a fact, the type of the second description, the information that identifies the second document, and the information that identifies the second reference of the second description extracted from the second document can be registered in the knowledge graph in association with each other. For example, in the case where the first document includes the first description indicated as a fact, the type of the first description, the information that identifies the first document, and the information that identifies the first reference of the first description can be registered in the knowledge graph in association with each other. As a result, a novel information processing system that is highly convenient, useful, or reliable can be provided.

(8) One embodiment of the present invention is the above-described information processing system, in which the first component is configured to receive a third node and provide the third node.

The third component is configured to transmit the third node to the first component, the management system is configured to obtain the third node from the knowledge graph in accordance with a third query and share the third node inside the third component.

The second subcomponent is configured to create the third query. The third query includes a request to collect a node classified into the type from the knowledge graph and create a result set and a request to collect, from the result set, the third node in which the fourth attribute value pair does not store information that identifies a document in the result set.

With this structure, descriptions classified into the type can be collected in the result set. For example, a description classified into the type in the second document included in the public information group and a description classified into the same type in the first document can be collected in the result set. Using information stored in the fourth attribute value pair, the third node that does not refer to a document including a description classified into the same type can be found. Moreover, a description that does not refer to a document including a description classified into the same type can be found. Furthermore, a document including the description can be found. As a result, a novel information processing system that is highly convenient, useful, or reliable can be provided.

(9) One embodiment of the present invention is the above-described information processing system, in which the first component is configured to receive a hearsay path and provide the hearsay path. Note that the hearsay path includes a chain including a source node and a destination node and starting from the third node.

The third component is configured to transmit the hearsay path to the first component. The management system is configured to obtain the hearsay path from the knowledge graph in accordance with a fourth query and share the hearsay path inside the third component.

The second subcomponent is configured to create the fourth query. The fourth query includes a request to collect the chain including the source node and the destination node and starting from the third node from the result set, and the fourth attribute value pair of the destination node stores information that identifies a document stored in the third attribute value pair of the source node.

With this structure, the hearsay path starting from the third node can be found from the result set. Moreover, a spread of the hearsay path starting from a document including a description that does not refer to a document including a description classified into the same type can be found. As a result, a novel information processing system that is highly convenient, useful, or reliable can be provided.

(10) One embodiment of the present invention is the above-described information processing system, in which the large language model is configured to generate a third description in accordance with the first prompt.

The first instruction includes a procedure for extracting the third description expressed as an opinion or a comment from the first document.

The knowledge graph includes a fourth node, and the first subcomponent is configured to create the fourth node. The fourth node includes a second label, and the second label is added to a node storing a description expressed as an opinion or a comment.

The fourth node includes a fifth attribute value pair capable of storing the third description, the second attribute value pair capable of storing the type, and the third attribute value pair capable of storing information that identifies the first document.

With this structure, the third description expressed as an opinion or a comment can be expressed in the knowledge graph. In the case where the first document includes the third description expressed as an opinion or a comment, the type of the third description and the information that identifies the first document can be registered in the knowledge graph in association with each other. As a result, a novel information processing system that is highly convenient, useful, or reliable can be provided.

(11) One embodiment of the present invention is the above-described information processing system, in which the first component is configured to receive a third node and provide the third node.

The third component is configured to transmit the third node to the first component, and the management system is configured to obtain the third node from the knowledge graph in accordance with a fifth query and share the third node inside the third component.

The second subcomponent is configured to create the fifth query. The fifth query includes a request to collect a node classified into the type from the knowledge graph and create a result set and a request to collect the third node from the result set.

The third node includes the first label, and information stored in the third attribute value pair of the fourth node including the second label is stored in the fourth attribute value pair.

With this structure, descriptions classified into the type can be collected in the result set. For example, in the case where the first description indicated as a fact and the third description expressed as an opinion or a comment are both classified into the type, the first description and the third description can be collected in the result set. Moreover, it is possible to find the third node in which the description indicated as a fact but classified into the same type uses, as a reference, the document including the third description expressed as an opinion or a comment. As a result, a novel information processing system that is highly convenient, useful, or reliable can be provided.

(12) One embodiment of the present invention is an information processing method including a first step, a second step, a third step, a fourth step, a fifth step, a sixth step, a seventh step, an eighth step, a ninth step, a tenth step, an eleventh step, a twelfth step, a thirteenth step, a fourteenth step, a fifteenth step, a sixteenth step, a seventeenth step, an eighteenth step, and a nineteenth step.

In the first step, a first component receives a document and transmits the document to a second component.

In the second step, the second component receives the document and transmits a first prompt to a third component,

The second component includes a first subcomponent and a second subcomponent. The first subcomponent is configured to perform processing with a database and a management system, and the database is configured to store a public information group and a business information group. The second subcomponent is configured to create the first prompt. The first prompt includes a first instruction and the document, and the first instruction includes a procedure for extracting a description indicated as a fact from the document.

In the third step, the third component receives the first prompt and generates the description with a large language model.

In the fourth step, the third component transmits the description to the second component.

In the fifth step, the second component receives the description and shares the description inside the second component.

In the sixth step, the second subcomponent creates a first query and shares the first query inside the second component. The first query includes a request to collect information including the description from the public information group.

In the seventh step, the first subcomponent obtains public information from the database in accordance with the first query with the management system and shares the public information inside the second component.

In the eighth step, the second subcomponent creates a second prompt and transmits the second prompt to the third component. The second prompt includes a second instruction, the description, and the public information, and the second instruction includes a procedure for generating a first evaluation. The first evaluation expresses consistency between the public information and the description.

In the ninth step, the third component receives the second prompt and generates the first evaluation with the large language model.

In the tenth step, the third component transmits the first evaluation to the second component.

In the eleventh step, the second component receives the first evaluation and shares the first evaluation inside the second component.

In the twelfth step, the second subcomponent creates a second query and shares the second query inside the second component. The second query includes a request to collect information including the description from the business information group.

In the thirteenth step, the first subcomponent obtains business information from the database in accordance with the second query with the management system and shares the business information inside the second component.

In the fourteenth step, the second subcomponent creates a third prompt and transmits the third prompt to the third component. The third prompt includes a third instruction, the description, and the business information, and the third instruction includes a procedure for generating a second evaluation. The second evaluation expresses consistency between the business information and the description.

In the fifteenth step, the third component receives the third prompt and generates the second evaluation with the large language model.

In the sixteenth step, the third component transmits the second evaluation to the second component.

In the seventeenth step, the second component receives the second evaluation and shares the second evaluation inside the second component.

The second component includes a third subcomponent, and the third subcomponent is configured to create a message on the basis of the first evaluation and the second evaluation.

In the eighteenth step, the third subcomponent creates the message and transmits the message to the first component. When the first evaluation is lower than a set evaluation and the second evaluation is higher than the set evaluation, the message reports that the description includes information that is not included in the public information group but included in the business information group.

In the nineteenth step, the first component receives the message and provides the message.

With this structure, whether the document indicates undisclosed information as a fact can be evaluated. Furthermore, a document that indicates undisclosed information as a fact can be found and a message can be provided to the user of the information processing system, for example. As a result, a novel information processing method that is highly convenient, useful, or reliable can be provided.

(13) One embodiment of the present invention is the above-described information processing method further including a twentieth step, a twenty-first step, a twenty-second step, a twenty-third step, a twenty-fourth step, a twenty-fifth step, a twenty-sixth step, twenty-seventh step, and a twenty-eighth step following the nineteenth step.

In the twentieth step, the second subcomponent creates a fourth prompt and transmits the fourth prompt to the third component. The fourth prompt includes a fourth instruction and the description, and the fourth instruction includes a procedure for classifying the description into a type.

In the twenty-first step, the third component receives the fourth prompt and generates the type with the large language model.

In the twenty-second step, the third component transmits the type to the second component.

In the twenty-third step, the second component receives the type and shares the type inside the second component.

In the twenty-fourth step, the second component creates a fifth prompt and transmits the fifth prompt to the third component. The fifth prompt includes a fifth instruction, the description, and the document, and the fifth instruction includes a procedure for extracting a reference of the description from the document.

In the twenty-fifth step, the third component receives the fifth prompt and identifies the reference with the large language model.

In the twenty-sixth step, the third component transmits the reference to the second component.

In the twenty-seventh step, the second component receives the reference and shares the reference inside the second component.

In the twenty-eighth step, the first subcomponent creates a node. The database is configured to store a knowledge graph, and the knowledge graph includes the node.

The node includes a label. The label is added to a node storing a description indicated as a fact. The node includes the label, a first attribute value pair capable of storing the description, a second attribute value pair capable of storing the type, a third attribute value pair capable of storing information that identifies the document, and a fourth attribute value pair capable of storing information that identifies the reference.

With this structure, a description indicated as a fact in the document can be expressed in the knowledge graph. For example, in the case where the document includes a description indicated as a fact, the type of the description, the information that identifies the document, and the information that identifies the reference of the description can be registered in the knowledge graph in association with each other. As a result, a novel information processing method that is highly convenient, useful, or reliable can be provided.

With one embodiment of the present invention, a novel information processing system that is highly convenient, useful, or reliable can be provided. A novel information processing method that is highly convenient, useful, or reliable can be provided. A novel information processing system, a novel information processing method, or a novel semiconductor device can be provided.

The description of these effects does not preclude the presence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

FIG. 1 illustrates a structure of an information processing system of an embodiment.

FIG. 2 illustrates a structure of a component used in an information processing system of an embodiment.

FIGS. 3A to 3C each illustrate a structure of a prompt used in an information processing system of an embodiment.

FIGS. 4A and 4B each illustrate a structure of a prompt used in an information processing system of an embodiment.

FIGS. 5A to 5C illustrate a structure of a knowledge graph used in an information processing system of an embodiment.

FIGS. 6A to 6C illustrate a structure of a knowledge graph used in an information processing system of an embodiment.

FIGS. 7A to 7D illustrate a structure of a knowledge graph used in an information processing system of an embodiment.

FIGS. 8A to 8C illustrate a structure of a knowledge graph used in an information processing system of an embodiment.

FIG. 9 illustrates a structure of an information processing device used for an information processing system of an embodiment.

FIG. 10 illustrates an information processing method of an embodiment.

### DETAILED DESCRIPTION OF THE INVENTION

An information processing system of one embodiment of the present invention includes a first component, a second component, and a third component.

The first component is configured to receive a first document and transmit the first document to the third component and to receive a message and provide the message.

The second component is configured to receive a first prompt and a second prompt and transmit a first description and a first evaluation to the third component and to perform processing with a large language model. The large language model is configured to generate the first description in accordance with the first prompt and to generate the first evaluation in accordance with the second prompt.

The third component is configured to receive the first document, the first description, and the first evaluation and share the first document, the first description, and the first evaluation inside the third component, to create the first prompt and the second prompt and transmit the first prompt and the second prompt to the second component, and to create the message and transmit the message to the first component. The third component includes a first subcomponent, a second subcomponent, and a third subcomponent.

The first subcomponent is configured to perform processing with a database and a management system and to obtain public information and share the public information inside the third component. The database is configured to store a public information group, and the management system is configured to obtain the public information from the public information group in accordance with a first query,

The second subcomponent is configured to create the first prompt, the first query, and the second prompt. The first prompt includes a first instruction and the first document, and the first instruction includes a procedure for extracting the first description indicated as a fact from the first document. The first query includes a request to collect information including the first description from the public information group. The second prompt includes a second instruction, the first description, and the public information, and the second instruction includes a procedure for generating the first evaluation. The first evaluation expresses consistency between the public information and the first description.

The third subcomponent is configured to create the message on the basis of the first evaluation.

With this structure, consistency between the first description indicated as a fact in the first document and the public information can be evaluated. When the first evaluation is lower than a set evaluation, a warning message can be provided to a user of the information processing system, for example. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components and thus do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

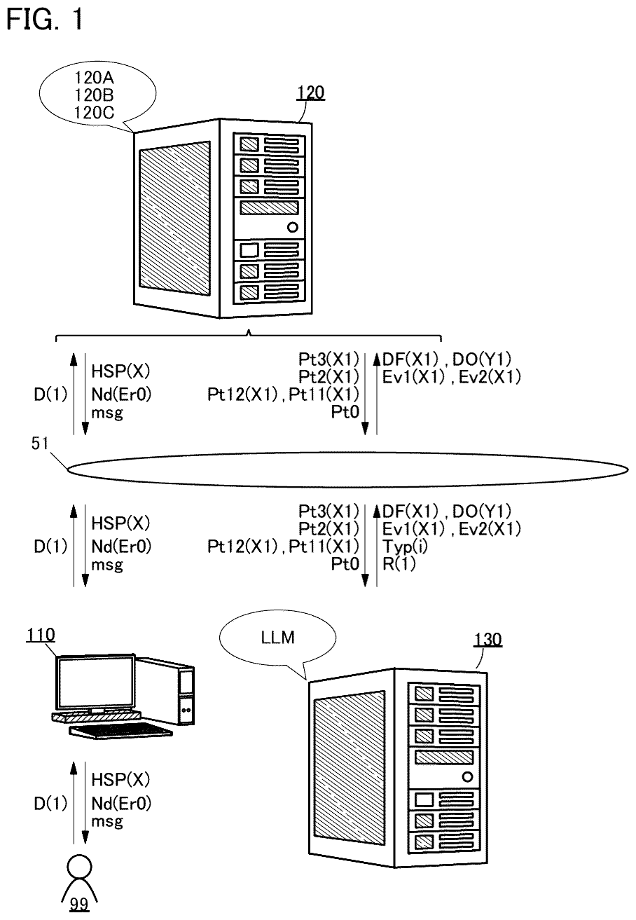

In this embodiment, an information processing system of one embodiment of the present invention will be described with reference to FIG. 1 to FIG. 9.

FIG. 1 illustrates a structure of the information processing system of one embodiment of the present invention.

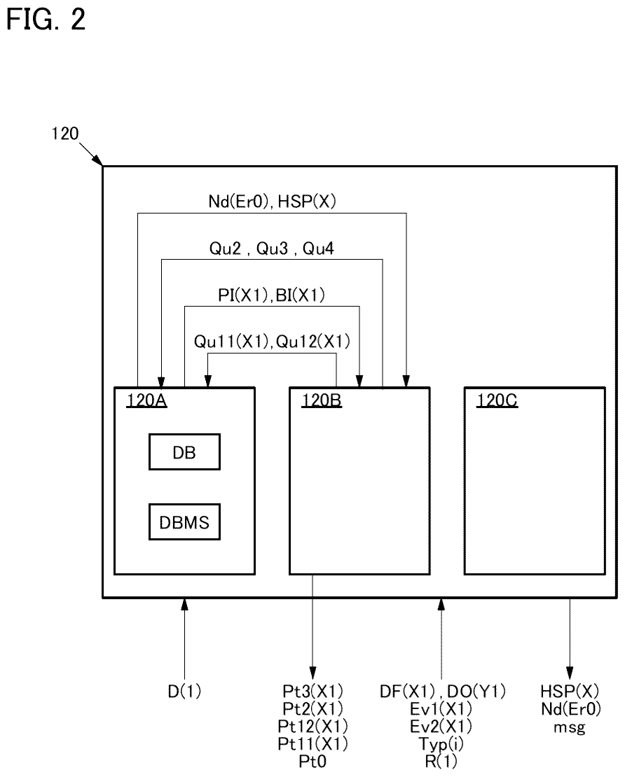

FIG. 2 illustrates a structure of a component used in the information processing system of one embodiment of the present invention.

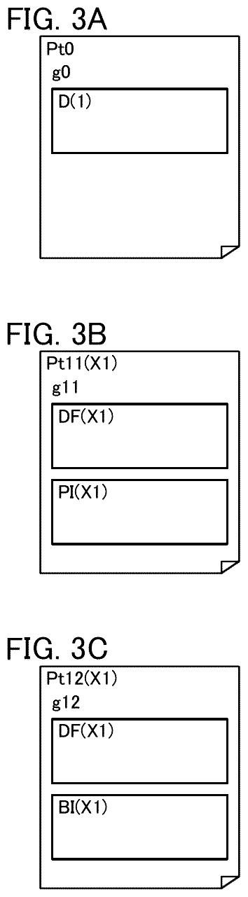

FIGS. 3A to 3C each illustrate a structure of a prompt transmitted and received inside the information processing system of one embodiment of the present invention.

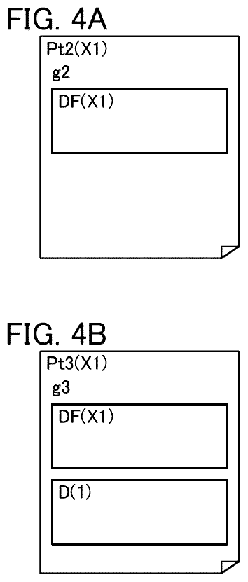

FIGS. 4A and 4B each illustrate a structure of a prompt transmitted and received inside the information processing system of one embodiment of the present invention.

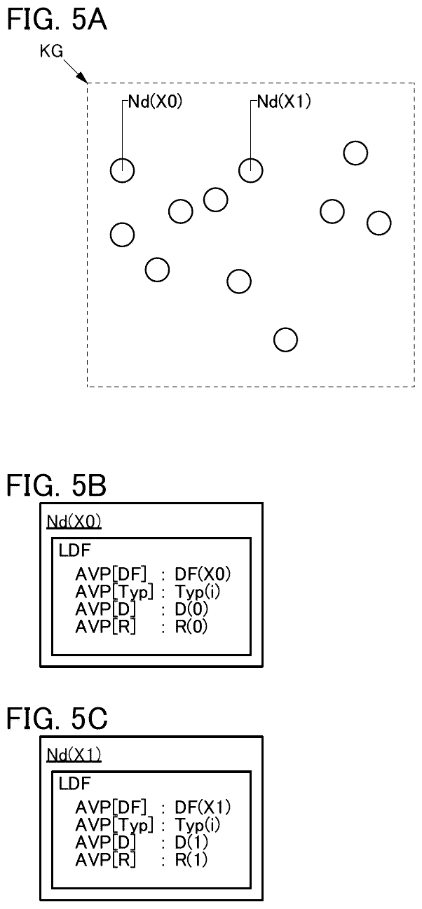

FIG. 5A is a diagram illustrating a structure of a knowledge graph that can be used in the information processing system of one embodiment of the present invention, and FIGS. 5B and 5C are diagrams each illustrating a structure of a node stored in the knowledge graph illustrated in FIG. 5A.

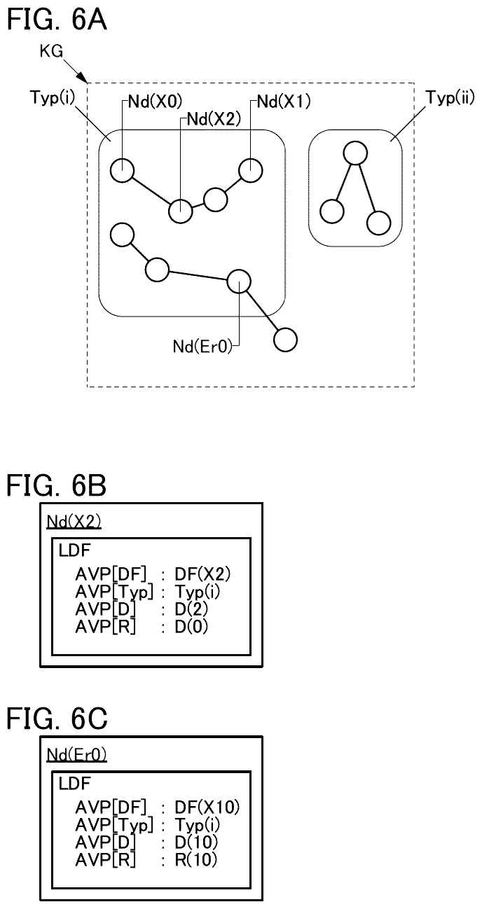

FIG. 6A is a diagram illustrating a structure of a knowledge graph that can be used in the information processing system of one embodiment of the present invention, and FIGS. 6B and 6C are diagrams each illustrating a structure of a node stored in the knowledge graph illustrated in FIG. 6A.

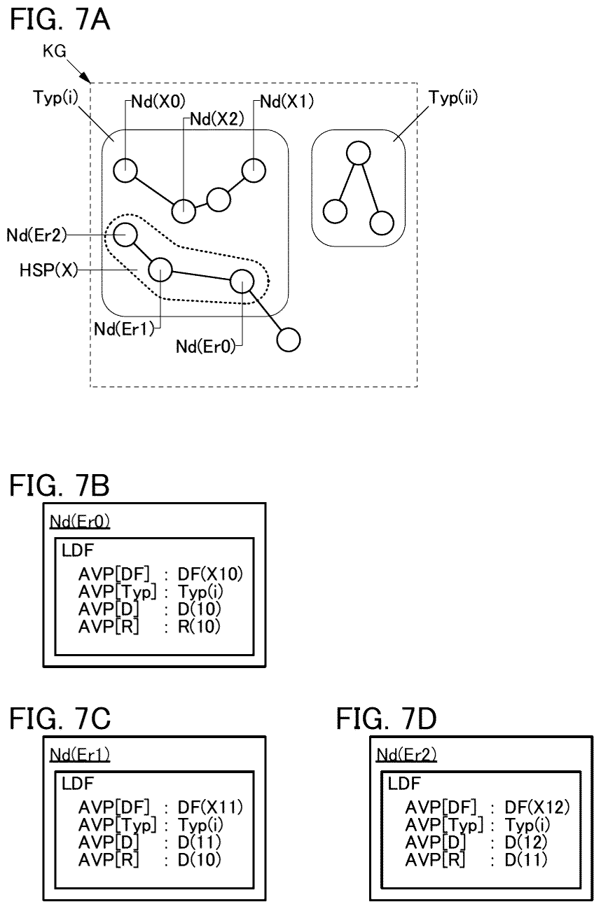

FIG. 7A is a diagram illustrating a structure of a knowledge graph that can be used in the information processing system of one embodiment of the present invention, and FIGS. 7B to 7D are diagrams each illustrating a structure of a node stored in the knowledge graph illustrated in FIG. 7A.

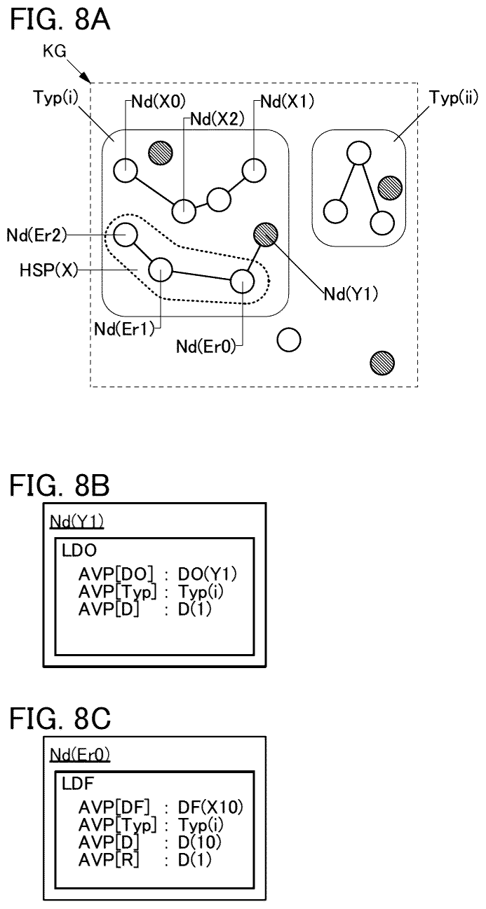

FIG. 8A is a diagram illustrating a structure of a knowledge graph that can be used in the information processing system of one embodiment of the present invention, and FIGS. 8B and 8C are diagrams each illustrating a structure of a node stored in the knowledge graph illustrated in FIG. 8A.

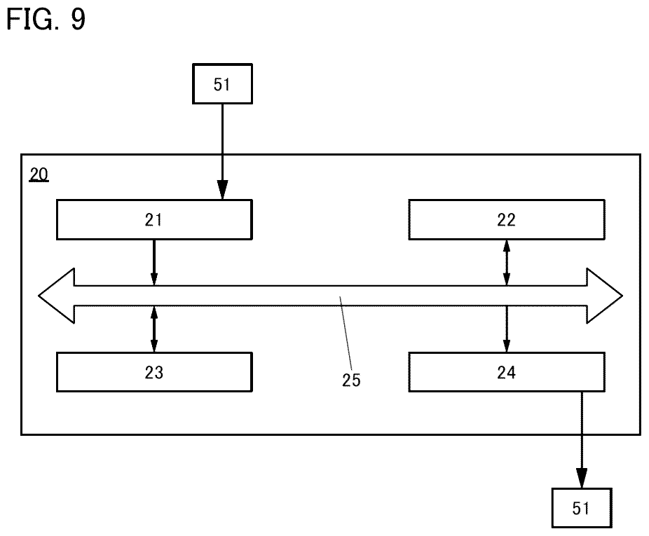

FIG. 9 is a block diagram illustrating a structure of an information processing device that can be used for the information processing system of one embodiment of the present invention.

### <Structure Example 1 of Information Processing System>

The information processing system of one embodiment of the present invention includes a component 110, a component 130, and a component 120 (see FIG. 1).

An information processing device serving a function of the component 110, an information processing device serving a function of the component 130, and an information processing device serving a function of the component 120 each include an arithmetic unit and a communication device, for example. The communication devices in the information processing devices can be connected to one another via a network 51 to construct the information processing system of one embodiment of the present invention.

### <Structure Example 1 of Component 110>

The component 110 has a function of receiving a document D(1) and transmitting it to the component 120. Furthermore, the component 110 has a function of receiving a message msg and providing it to a user 99 of the information processing system, for example. Specifically, the message msg is provided to the user 99 of the information processing system with an output device such as a display device, a speaker, a printer, a facsimile machine, or a memory device.

For example, the user 99 of the information processing system inputs the document D(1) to the component 110. Alternatively, the user 99 inputs a command for selecting and transmitting the document D(1) stored in a memory device to the component 110, for example. Specifically, the user 99 of the information processing system inputs the document D(1) or the command to the component 110 with an input device such as a keyboard, a mouse, a facsimile machine, or an eye-gaze input device.

For example, a news story, a blog article, or the like regarding the user 99 of the information processing system or a corporation the user 99 belongs to can be used as the document D(1). Specifically, a document disclosed in media, mass media (e.g., a newspaper, a television, or a journal), Internet media (web media (primary media, secondary media), or social media), or the like by another person or another corporation can be used as the document D(1).

### <Structure Example 1 of Component 130>

The component 130 has a function of receiving a prompt Pt0 and a prompt Pt11(X1). Furthermore, the component 130 has a function of transmitting a description DF(X1) and an evaluation Ev1(X1) to the component 120 and a function of performing processing with a large language model LLM.

### <<Structure Example 1 of Large Language Model LLM>>

The large language model LLM has a function of generating the description DF(X1) in accordance with the prompt Pt0. In addition, the large language model LLM has a function of generating the evaluation Ev1(X1) in accordance with the prompt Pt11(X1).

A large language model such as GPT-3 (registered trademark), GPT-3.5, GPT-4 (registered trademark), LaMDA, Llama2, or Llama3 can be used as the large language model LLM.

### <Structure Example 1 of Component 120>

The component 120 has a function of receiving the document D(1), the description DF(X1), and the evaluation Ev1(X1) and sharing them inside the component 120. In addition, the component 120 has a function of creating the prompt Pt0 and the prompt Pt11(X1) and transmitting them to the component 130 and a function of creating the message msg and transmitting it to the component 110.

The component 120 includes a subcomponent 120A, a subcomponent 120B, and a subcomponent 120C (see FIG. 2). In this specification, a structure having a single function or a plurality of functions is referred to as a component or a subcomponent for description convenience.

### <<Structure Example 1 of Subcomponent 120A>>

The subcomponent 120A has a function of performing processing with a database DB and a management system DBMS and a function of sharing public information PI(X1) inside the component 120.

The database DB has a function of storing a public information group PI, and the management system DBMS has a function of obtaining the public information PI(X1) from the public information group PI in accordance with a query Qu11(X1). For example, a document or the like disclosed by the user 99 of the information processing system or a corporation the user 99 belongs to can be used as the public information PI(X1). An archive containing a document or the like including the public information PI(X1) can be used as the public information group PI.

### <<Structure Example 1 of Subcomponent 120B>>

The subcomponent 120B has a function of creating the prompt Pt0, the query Qu11(X1), and the prompt Pt11(X1).

### [Structure Example 1 of Prompt Pt0]

The prompt Pt0 includes an instruction g0 and the document D(1) (see FIG. 3A). The instruction g0 includes a procedure for extracting the description DF(X1) indicated as a fact from the document D(1). In this specification, the description DF(X1) indicated as a fact refers to a description indicating some matter as a fact.

For example, a document in the next paragraph can be used as the prompt Pt0. “Extract only a part describing a fact from {the document D(1)}.”

### [Structure Example of Query Qu11(X1)]

The query Qu11(X1) includes a request to collect information including the description DF(X1) from the public information group PI. For example, information related to the public information group PI can be collected with a full-text search engine, indices of the public information group PI, and the description DF(X1).

### [Structure Example of Prompt Pt11(X1)]

The prompt Pt11(X1) includes an instruction g11, the description DF(X1), and the public information PI(X1) (see FIG. 3B). The instruction g11 includes a procedure for generating the evaluation Ev1(X1). Note that the evaluation Ev1(X1) expresses consistency between the public information PI(X1) and the description DF(X1). For example, in the case where the description DF(X1) cites the public information PI(X1) without any modifications, a high evaluation value can be used as the evaluation Ev1(X1). For example, in the case where the description DF(X1) shows a matter that is not in the public information PI(X1), a low evaluation value can be used as the evaluation Ev1(X1). In the case where the description DF(X1) includes a groundless description, that matter can be added to the message msg. In the case where the description DF(X1) includes a wrong description, that matter can be added to the message msg.

For example, a document in the next paragraph can be used as the prompt Pt11(X1).

“Answer whether {the description DF(X1)} is included in {the public information PI(X1)}. Answer as follows: all included (3 points); partly included (2 points); not included at all (1 point).”

### <<Structure Example 1 of Subcomponent 120C>>

The subcomponent 120C has a function of creating the message msg on the basis of the evaluation Ev1(X1). For example, a message to the effect that the description DF(X1) almost accurately tells the public information PI(X1) can be used as the message msg. A message to the effect that the description DF(X1) is inaccurate can be used as the message msg.

With this structure, consistency between the description DF(X1) indicated as a fact in the document D(1) and the public information PI(X1) can be evaluated. When the evaluation Ev1(X1) is lower than a set evaluation, a warning message msg can be provided to a user of the information processing system, for example. A disclosure by another person of a matter regarding the user of the information processing system or a corporation the user belongs to that is not a fact or has not been made public can be picked out. As a result, a novel information processing system that is highly convenient, useful, or reliable can be provided.

### <Structure Example 2 of Component 130>

The component 130 has a function of receiving a prompt Pt12(X1). In addition, the component 130 has a function of transmitting an evaluation Ev2(X1) to the component 120.

### <<Structure Example 2 of Large Language Model LLM>>

The large language model LLM has a function of generating the evaluation Ev2(X1) in accordance with the prompt Pt12(X1).

### <Structure Example 2 of Component 120>

The component 120 has a function of receiving the evaluation Ev2(X1) and sharing it inside the component 120. In addition, the component 120 has a function of creating the prompt Pt12(X1) and transmitting it to the component 130.

<<structure Example 2 of Subcomponent 120A>>

The subcomponent 120A has a function of sharing business information BI(X1) inside the component 120.

The database DB has a function of storing a business information group BI, and the management system DBMS has a function of obtaining the business information BI(X1) from the business information group BI in accordance with a query Qu12(X1). For example, a document or the like created for a business purpose by the user 99 of the information processing system or a corporation the user 99 belongs to can be used as the business information BI(X1). An archive containing a document or the like including the business information BI(X1) can be used as the business information group BI. Note that the business information group BI includes not only the public information group PI but also confidential documents or the like.

### <<Structure Example 2 of Subcomponent 120B>>

The subcomponent 120B has a function of creating the query Qu12(X1) and the prompt Pt12(X1).

### [Structure Example of Query Qu12(X1)]

The query Qu12(X1) includes a request to collect information including the description DF(X1) from the business information group BI. For example, information related to the business information group BI can be collected with a full-text search engine, indices of the business information group BI, and the description DF(X1).

### [Structure Example of Prompt Pt12(X1)]

The prompt Pt12(X1) includes an instruction g12, the description DF(X1), and the business information BI(X1) (see FIG. 3C). The instruction g12 includes a procedure for generating the evaluation Ev2(X1). Note that the evaluation Ev2(X1) expresses consistency between the business information BI(X1) and the description DF(X1). For example, in the case where the description DF(X1) cites the business information BI(X1) without any modifications, a high evaluation value can be used as the evaluation Ev2(X1). For example, in the case where the description DF(X1) shows a matter that is not in the business information BI(X1), a low evaluation value can be used as the evaluation Ev2(X1). In the case where the description DF(X1) includes a groundless description, that matter can be added to the message msg. In the case where the description DF(X1) includes a wrong description, that matter can be added to the message msg.

For example, a document in the next paragraph can be used as the prompt Pt12(X1).

“Answer whether {the description DF(X1)} is included in {the business information BI(X1)}. Answer as follows: all included (3 points); partly included (2 points); not included at all (1 point).”

### <<Structure Example 2 of Subcomponent 120C>>

The subcomponent 120C has a function of creating the message msg on the basis of the evaluation Ev2(X1). For example, a message to the effect that the description DF(X1) almost accurately tells the business information BI(X1) can be used as the message msg. A message to the effect that the description DF(X1) is inaccurate can be used as the message msg.

With this structure, consistency between the description DF(X1) indicated as a fact in the document D(1) and the business information BI(X1) can be evaluated. As a result, a novel information processing system that is highly convenient, useful, or reliable can be provided.

### <<Structure Example 3 of Subcomponent 120C>>

When the evaluation Ev1(X1) is lower than a set evaluation and the evaluation Ev2(X1) is higher than the set evaluation, the subcomponent 120C can create a special message.

For example, the message msg reports that the description DF(X1) includes information that is not included in the public information group PI but included in the business information group BI.

With this structure, whether the document (D1) indicates undisclosed information as a fact can be evaluated. Furthermore, the document (D1) that indicates undisclosed information as a fact can be found and the message msg can be provided to the user of the information processing system, for example. As a result, a novel information processing system that is highly convenient, useful, or reliable can be provided.

### <Structure Example 3 of Component 130>

The component 130 has a function of receiving a prompt Pt2(X1) and transmitting a type Typ(i) to the component 120.

### <<Structure Example 3 of Large Language Model LLM>>

The large language model LLM has a function of classifying the description DF(X1) into the type Typ(i) in accordance with the prompt Pt2(X1). For example, a plurality of types can be given so that the type that applies can be selected.

Specifically, the user 99 of the information processing system can set a plurality of topics, and each topic can be used as a type. In the case where one description includes a plurality of topics, the description is classified into a plurality of types. Such classification is referred to as multi-label classification in some cases. For instance, in the case of an article regarding a business operator conducting mail-order sales, the operator's name, address and phone number, the selling price of products or services, the payment method and timing, the product delivery timing, return or exchange policies, other product-specific required information, and the like can be used as types which the description is classified into.

The number of types in classification can be set by the user 99 of the information processing system. Note that one description is classified into any one type. Such classification is referred to as multi-class classification in some cases.

### <Structure Example 3 of Component 120>

The component 120 has a function of transmitting the prompt Pt2(X1) to the component 130 and a function of receiving the type Typ(i) and sharing it inside the component 120.

### <<Structure Example 3 of Subcomponent 120B>>

The subcomponent 120B has a function of creating the prompt Pt2(X1).

### [Structure Example of Prompt Pt2(X1)]

The prompt Pt2(X1) includes an instruction g2 and the description DF(X1) (see FIG. 4A). The instruction g2 includes a procedure for classifying the description DF(X1) into the type Typ(i).

For example, a document in the next paragraph can be used as the prompt Pt2(X1).

“Classify {the description DF(X1)} into any {type}.”

Thus, the description DF(X1) indicated as a fact in the document D(1) can be classified into the type Typ(i). As a result, a novel information processing system that is highly convenient, useful, or reliable can be provided.

### <Structure Example 4 of Component 130>

The component 130 has a function of receiving a prompt Pt3(X1) and transmitting a reference R(1) to the component 120.

### <<Structure Example 4 of Large Language Model LLM>>

The large language model LLM has a function of identifying the reference R(1) in accordance with the prompt Pt3(X1).

### <Structure Example 4 of Component 120>

The component 120 has a function of transmitting the prompt Pt3(X1) to the component 130 and a function of receiving the reference R(1) and sharing it inside the component 120.

### <<Structure Example 4 of Subcomponent 120B>>

The subcomponent 120B has a function of creating the prompt Pt3(X1).

### [Structure Example of Prompt Pt3(X1)]

The prompt Pt3(X1) includes an instruction g3, the description DF(X1), and the document D(1) (see FIG. 4B). The instruction g3 includes a procedure for extracting the reference R(1) of the description DF(X1) from the document D(1). For example, the reference R(1) of the description DF(X1) is extracted from the descriptions, footnotes, or the like in the document D(1).

For example, a document in the next paragraph can be used as the prompt Pt3(X1).

“Extract a reference of the description DF(X1) from the document D(1).”

Thus, the reference R(1) of the description DF(X1) indicated as a fact in the document D(1) can be extracted from the document D(1). As a result, a novel information processing system that is highly convenient, useful, or reliable can be provided.

### <Structure Example 2 of Information Processing System>

The information processing system of one embodiment of the present invention has a function of managing a description indicated as a fact with a knowledge graph KG.

### <Structure Example 5 of Component 120>

The component 120 has a function of managing information transmitted and received inside the information processing system of one embodiment of the present invention.

### <<Structure Example 3 of Subcomponent 120A>>

The database DB of the subcomponent 120A has a function of storing the knowledge graph KG. The knowledge graph KG includes a node Nd(X0) and a node Nd(X1) (see FIG. 5A).

The subcomponent 120A also has a function of creating the node Nd(X0) and the node Nd(X1). The node Nd(X0) and the node Nd(X1) each include a label LDF (see FIG. 5B and FIG. 5C). Note that the label LDF is added to a node that stores a description indicated as a fact.

### [Structure Example of Node Nd(X0)]

The node Nd(X0) includes an attribute value pair AVP[DF] that can store a description DF(X0), an attribute value pair AVP[Typ] that can store the type Typ(i), an attribute value pair AVP[D] that can store information that identifies a document D(0), and an attribute value pair AVP[R] that can store information that identifies a reference R(0). Note that an attribute value pair includes an attribute and the value of the attribute. In addition, various types of data with various structures such as a numerical value, a character string, and an arrangement can be used as an attribute value.

The description DF(X0) is a description indicated as a fact in the document D(0) included in the public information group PI.

The reference R(0) is a reference of the description DF(X0) written in the document D(0).

### [Structure Example of Node Nd(X1)]

The node Nd(X1) includes the label LDF, the attribute value pair AVP[DF] that can store the description DF(X1), the attribute value pair AVP[Typ] that can store the type Typ(i), the attribute value pair AVP[D] that can store information that identifies the document D(1), and the attribute value pair AVP[R] that can store information that identifies the reference R(1).

With this structure, the description DF(X0) indicated as a fact in the document D(0) included in the public information group PI and the description DF(X1) indicated as a fact in the document D(1) can be expressed in the knowledge graph KG. For example, in the case where the document D(0) included in the public information group PI includes the description DF(X0) indicated as a fact, the type Typ(i) of the description DF(X0), information that identifies the document D(0), and information that identifies the reference R(0) of the description DF(X0) that is extracted from the document D(0) can be registered in the knowledge graph KG in association with each other. Furthermore, for example, in the case where the document D(1) includes the description DF(X1) indicated as a fact, the type Typ(i) of the description DF(X1), information that identifies the document D(1), and information that identifies the reference R(1) of the description DF(X1) can be registered in the knowledge graph KG in association with each other. As a result, a novel information processing system that is highly convenient, useful, or reliable can be provided.

### <Structure Example 2 of Component 110>

The component 110 has a function of receiving a node Nd(Er0) and providing it to the user 99 of the information processing system, for example (see FIG. 1).

### <Structure Example 6 of Component 120>

The component 120 has a function of transmitting the node Nd(Er0) to the component 110.

### <<Structure Example 4 of Subcomponent 120A>>

The management system DBMS of the subcomponent 120A has a function of obtaining the node Nd(Er0) from the knowledge graph KG in accordance with a query Qu2 and sharing it inside the component 120 (see FIG. 2).

### <<Structure Example 5 of Subcomponent 120B>>

The subcomponent 120B has a function of creating the query Qu2.

### [Structure Example of Query Qu2]

The query Qu2 includes a request to collect a node classified into the type Typ(i) from the knowledge graph KG and to create a result set RS(i). In other words, with the query Qu2, a node that stores a description classified into the type Typ(i) can be collected from a plurality of documents in the result set RS(i). In addition, information that identifies a reference of the description classified into the type Typ(i) can be collected in the result set RS(i). For example, the node classified into the type Typ(i) and the node classified into a type Typ(ii) can be illustrated as in FIG. 6A. The nodes classified into the type Typ(i) in FIG. 6A are collected in the result set RS(i).

The query Qu2 includes a request for the attribute value pair AVP[R] to collect the node Nd(Er0) that does not store information identifying a document in the result set RS(i) from the result set RS(i). In other words, with the query Qu2, it is possible to find a node that does not refer to the document in the result set RS(i) among the nodes that store descriptions classified into the type Typ(i). For example, the node Nd(X0), the node Nd(X1), and a node Nd(X2) each refer to a node (the node classified into the type Typ(i)) in the result set RS(i) (see FIG. 5B, FIG. 5C, and FIG. 6B). In the node Nd(X2), the attribute value pair AVP[DF] stores a description DF(X2), the attribute value pair AVP[Typ] stores the type Typ(i), the attribute value pair AVP[D] stores information that identifies a document D(2), and the attribute value pair AVP[R] stores information that identifies the document D(0). In contrast, the node Nd(Er0) refers to a node that is not classified into the type Typ(i) (see FIG. 6A and FIG. 6C). In the node Nd(Er0), the attribute value pair AVP[DF] stores a description DF(X10), the attribute value pair AVP[Typ] stores the type Typ(i), the attribute value pair AVP[D] stores information that identifies a document D(10), and the attribute value pair AVP[R] stores information that identifies a reference R(10). The reference R(10) is a document that does not include a description classified into the type Typ(i).

With this structure, descriptions classified into the type Typ(i) can be collected in the result set RS(i). For example, a description classified into the type Typ(i) in the document D(0) included in the public information group PI and a description classified into the same type Typ(i) in the document D(1) can be collected in the result set RS(i). Using information stored in the attribute value pair AVP[R], the node Nd(Er0) that does not refer to a document including a description classified into the same type Typ(i) can be found. Moreover, a description that does not refer to a document including a description classified into the same type Typ(i) can be found. Furthermore, a document including the description can be found. As a result, a novel information processing system that is highly convenient, useful, or reliable can be provided.

### <Structure Example 3 of Component 110>

The component 110 has a function of receiving a hearsay path HSP(X) and providing it to the user 99 of the information processing system, for example (see FIG. 1). Note that the hearsay path HSP(X) includes a chain of source and destination nodes starting from the node Nd(Er0) (see FIG. 7A).

### <Structure Example 7 of Component 120>

The component 120 has a function of transmitting the hearsay path HSP(X) to the component 110 (see FIG. 1).

### <<Structure Example 5 of Subcomponent 120A>>

The management system DBMS of the subcomponent 120A has a function of obtaining the hearsay path HSP(X) from the knowledge graph KG in accordance with a query Qu3 and sharing it inside the component 120 (see FIG. 2).

### <<Structure Example 6 of Subcomponent 120B>>

The subcomponent 120B has a function of creating the query Qu3.

### [Structure Example of Query Qu3]

The query Qu3 includes a request to collect the chain of the source and destination nodes starting from the node Nd(Er0) from the result set RS(i). The attribute value pair AVP[R] of the destination node stores information that identifies a document stored in the attribute value pair AVP[D] of the source node.

For example, in the case of the hearsay path HSP(X) starting from the node Nd(Er0), the attribute value of the attribute value pair AVP[R] of the destination node Nd(Er1) is information that identifies the document D(10), and the attribute value of the attribute value pair AVP[D] of the source node Nd(Er0) is information that identifies the document D(10) (see FIGS. 7A to 7C). In the node Nd(Er1), the attribute value pair AVP[DF] stores a description DF(X11), the attribute value pair AVP[Typ] stores the type Typ(i), and the attribute value pair AVP[D] stores information that identifies a document D(11). Furthermore, the attribute value of the attribute value pair AVP[R] of a destination node Nd(Er2) is information that identifies a document D(11), and the attribute value of the attribute value pair AVP[D] of the source node Nd(Er1) is information that identifies the document D(11) (see FIGS. 7A, 7C, and 7D). In the node Nd(Er2), the attribute value pair AVP[DF] stores a description DF(X12), the attribute value pair AVP[Typ] stores the type Typ(i), and the attribute value pair AVP[D] stores information that identifies a document D(12).

With this structure, the hearsay path HSP(X) starting from the node Nd(Er0) can be found from the result set RS(i). Moreover, a spread of the hearsay path HSP(X) starting from a document including a description that does not refer to a document including a description classified into the same type Typ(i) can be found. As a result, a novel information processing system that is highly convenient, useful, or reliable can be provided.

### <Structure Example 3 of Information Processing System>

The information processing system of one embodiment of the present invention has a function of managing, with the knowledge graph KG, not only a description indicated as a fact but also a description expressed as an opinion or a comment.

### <Structure Example 5 of Component 130>

The component 130 has a function of receiving the prompt Pt0. Furthermore, the component 130 has a function of transmitting a description DO(Y1) to the component 120 (see FIG. 1).

### <<Structure Example 1 of Large Language Model LLM>>

The large language model LLM has a function of generating the description DO(Y1) in accordance with the prompt Pt0.

### <Structure Example 8 of Component 120>

The component 120 has a function of receiving the description DO(Y1) and sharing it inside the component 120. In addition, the component 120 has a function of creating the prompt Pt0 and transmitting it to the component 130.

### <<Structure Example 7 of Subcomponent 120B>>

The subcomponent 120B has a function of creating the prompt Pt0.

### [Structure Example 2 of Prompt Pt0]

The prompt Pt0 includes the instruction g0 and the document D(1) (see FIG. 3A). The instruction g0 includes a procedure for extracting the description DF(X1) indicated as a fact and the description DO(Y1) expressed as an opinion or a comment from the document D(1). In this specification, the description DO(Y1) expressed as an opinion or a comment refers to a description expressing some opinion or comment.

For example, a document in the next paragraph can be used as the prompt Pt0. “Extract a part describing a fact from {the document D(1)} and extract a part describing an opinion or a comment from {the document D(1)}.”

### <<Structure Example 6 of Subcomponent 120A>>

The database DB of the subcomponent 120A has a function of storing the knowledge graph KG. The knowledge graph KG includes a node Nd(Y1) (see FIG. 8A). Note that a white circle in the graph represents a node in which a description indicated as a fact is stored, and a hatched circle in the graph represents a node in which a description expressed as an opinion or a comment is stored.

The subcomponent 120A has a function of creating the node Nd(Y1). The node Nd(Y1) includes a label LDO. Note that the label LDO is added to a node that stores a description expressed as an opinion or a comment.

### [Structure Example of Node Nd(Y1)]

The node Nd(Y1) includes an attribute value pair AVP[DO] that can store the description DO(Y1), the attribute value pair AVP[Typ] that can store the type Typ(i), and the attribute value pair AVP[D] that can store information that identifies the document D(1) (see FIG. 8B).

With this structure, the description DO(Y1) expressed as an opinion or a comment can be expressed in the knowledge graph KG. In the case where the document D(1) includes the description DO(Y1) expressed as an opinion or a comment, the type Typ(i) of the description DO(Y1) and the information that identifies the document D(1) can be registered in the knowledge graph KG in association with each other. As a result, a novel information processing system that is highly convenient, useful, or reliable can be provided.

### <Structure Example 4 of Component 110>

The component 110 has a function of receiving the node Nd(Er0) and providing it to the user 99 of the information processing system, for example (see FIG. 1).

### <Structure Example 9 of Component 120>

The component 120 has a function of transmitting the node Nd(Er0) to the component 110.

The management system DBMS has a function of obtaining the node Nd(Er0) from the knowledge graph KG in accordance with a query Qu4 and sharing it inside the component 120 (see FIG. 2).

### <<Structure Example 8 of Subcomponent 120B>>

The subcomponent 120B has a function of creating the query Qu4.

[structure Example of Query Qu4]

The query Qu4 includes a request to collect a node classified into the type Typ(i) from the knowledge graph KG and to create a result set RS(i). In other words, with the query Qu4, a node that stores a description classified into the type Typ(i) can be collected from a plurality of documents in the result set RS(i). In addition, information that identifies a reference of the description classified into the type Typ(i) can be collected in the result set RS(i).

The query Qu4 includes a request to collect the node Nd(Er0) from the result set RS(i). Note that the node Nd(Er0) includes the label LDF, and the attribute value pair AVP[R] stores information stored in the attribute value pair AVP[D] of the node Nd(Y1) including the label LDO (see FIG. 8C). In other words, with the query Qu4, it is possible to find, among nodes that store descriptions classified into the type Typ(i), a node that refers to a document including a description expressed as an opinion or a comment.

With this structure, a description classified into the type Typ(i) can be collected in the result set RS(i). For example, in the case where the description DF(X1) indicated as a fact and the description DO(Y1) expressed as an opinion or a comment are both classified into the type Typ(i), the description DF(X1) and the description DO(Y1) can be collected in the result set RS(i). Moreover, it is possible to find the node Nd(Er0) in which the description DF(X1) indicated as a fact but classified into the same type Typ(i) uses, as a reference, a document including the description DO(Y1) expressed as an opinion or a comment. As a result, a novel information processing system that is highly convenient, useful, or reliable can be provided.

### <Structure Example 4 of Information Processing System>

An information processing device 20 that can be used for the information processing system of one embodiment of the present invention includes, for example, an input unit 21, a storage unit 22, a processing unit 23, an output unit 24, and a transmission path 25 (see FIG. 9).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different information processing device depending on the processing.

### <<Input Unit 21>>

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### <<Storage Unit 22>>

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, the information processing device, or the information processing system. Alternatively, the information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or an indium gallium zinc oxide (an In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide included in the channel formation region may be, for example, a metal oxide that does not contain indium but contains any of zinc, gallium, and tin (e.g., a zinc tin oxide or a gallium tin oxide).

### <<Processing Unit 23>>

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### <<Output Unit 24>>

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

### <<Transmission Path 25>>

The transmission path 25 has a function of transmitting data. Data transmission and reception between the input unit 21, the storage unit 22, the processing unit 23, and the output unit 24 can be performed via the transmission path 25. Specifically, an external bus, a LAN, or the Internet can be used for the transmission path 25.

Note that this embodiment can be combined with any of the other embodiments in this specification as appropriate.

### Embodiment 2

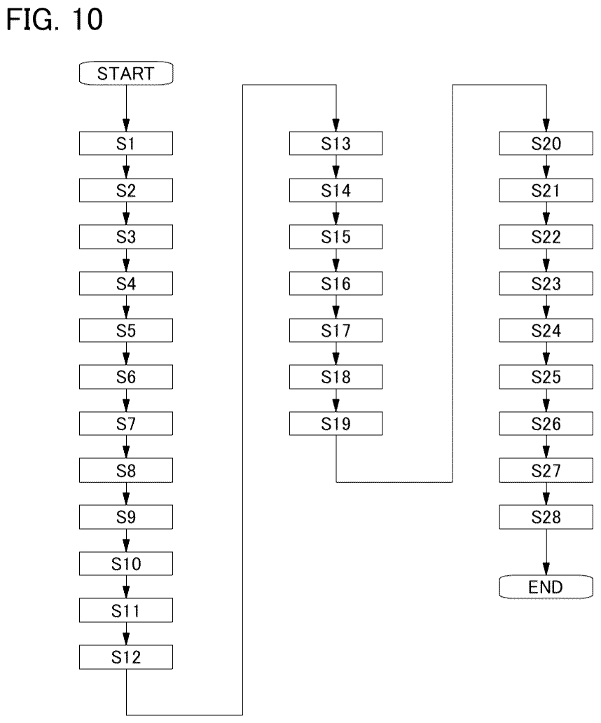

In this embodiment, an information processing method of one embodiment of the present invention will be described with reference to FIG. 10.

FIG. 10 is a flow diagram illustrating an information processing method of one embodiment of the present invention.

### <Example 1 of Information Processing Method>

The information processing method of one embodiment of the present invention includes Steps S1 to S19 (see FIG. 10).

### <Step S1>

In Step S1, the component 110 receives the document D(1) and transmits it to the component 120. For example, the user 99 of the information processing system inputs the document D(1) to the component 110.

### <Step S2>

In Step S2, the component 120 receives the document D(1) and transmits the prompt Pt0 to the component 130. The component 120 includes the subcomponent 120A and the subcomponent 120B.

The subcomponent 120A has a function of performing processing with the database DB and the management system DBMS. The database DB has a function of storing the public information group PI and the business information group BI.

The subcomponent 120B has a function of creating the prompt Pt0. Note that the prompt Pt0 includes the instruction g0 and the document D(1), and the instruction g0 includes a procedure for extracting the description DF(X1) indicated as a fact from the document D(1).

### <Step S3>

In Step S3, the component 130 receives the prompt Pt0 and generates the description DF(X1) with the large language model LLM.

### <Step S4>

In Step S4, the component 130 transmits the description DF(X1) to the component 120.

### <Step S5>

In Step S5, the component 120 receives the description DF(X1) and shares it inside the component 120.

### <Step S6>

In Step S6, the subcomponent 120B creates the query Qu11(X1) and shares it inside the component 120. Note that the query Qu11(X1) includes a request to collect information including the description DF(X1) from the public information group PI.

### <Step S7>

In Step S7, the subcomponent 120A obtains the public information PI(X1) from the database DB in accordance with the query Qu11(X1) with the management system DBMS and shares it inside the component 120.

### <Step S8>

In Step S8, the subcomponent 120B creates the prompt Pt11(X1) and transmits it to the component 130. Note that the prompt Pt11(X1) includes the instruction g11, the description DF(X1), and the public information PI(X1), and the instruction g11 includes a procedure for generating the evaluation Ev1(X1). The evaluation Ev1(X1) expresses consistency between the public information PI(X1) and the description DF(X1).

### <Step S9>

In Step S9, the component 130 receives the prompt Pt11(X1) and generates the evaluation Ev1(X1) with the large language model LLM.

### <Step S10>

In Step S10, the component 130 transmits the evaluation Ev1(X1) to the component 120.

### <Step S11>

In Step S11, the component 120 receives the evaluation Ev1(X1) and shares it inside the component 120.

### <Step S12>

In Step S12, the subcomponent 120B creates the query Qu12(X1) and shares it inside the component 120. Note that the query Qu12(X1) includes a request to collect information including the description DF(X1) from the business information group BI.

### <Step S13>

In Step S13, the subcomponent 120A obtains the business information BI(X1) from the database DB in accordance with the query Qu12(X1) with the management system DBMS and shares it inside the component 120.

### <Step S14>

In Step S14, the subcomponent 120B creates the prompt Pt12(X1) and transmits it to the component 130. Note that the prompt Pt12(X1) includes the instruction g12, the description DF(X1), and the business information BI(X1), and the instruction g12 includes a procedure for generating the evaluation Ev2(X1). The evaluation Ev2(X1) expresses consistency between the business information BI(X1) and the description DF(X1).

### <Step S15>

In Step S15, the component 130 receives the prompt Pt12(X1) and generates the evaluation Ev2(X1) with the large language model LLM.

### <Step S16>

In Step S16, the component 130 transmits the evaluation Ev2(X1) to the component 120.

### <Step S17>

In Step S17, the component 120 receives the evaluation Ev2(X1) and shares it inside the component 120. Note that the component 120 includes the subcomponent 120C, and the subcomponent 120C has a function of creating the message msg on the basis of the evaluation Ev1 (X1) and the evaluation Ev2 (X1).

### <Step S18>

In Step S18, the subcomponent 120C creates the message msg and transmits it to the component 110. When the evaluation Ev1(X1) is lower than a set evaluation and the evaluation Ev2(X1) is higher than the set evaluation, the message msg reports that the description DF(X1) includes information that is not included in the public information group PI but included in the business information group BI.

### <Step S19>

In Step S19, the component 110 receives the message msg and provides it to the user of the information processing system, for example.

With this structure, whether the document (D1) indicates undisclosed information as a fact can be evaluated. Furthermore, the document (D1) that indicates undisclosed information as a fact can be found and the message msg can be provided to the user of the information processing system, for example. As a result, a novel information processing method that is highly convenient, useful, or reliable can be provided.

### <Example 2 of Information Processing Method>

An information processing method of one embodiment of the present invention is an information processing method including Steps S20 to S28 following the above-described information processing method (see FIG. 10).

### <Step S20>

In Step S20, the subcomponent 120B creates the prompt Pt2(X1) and transmits it to the component 130. Note that the prompt Pt2(X1) includes the instruction g2 and the description DF(X1), and the instruction g2 includes a procedure for classifying the description DF(X1).

### <Step S21>

In Step S21, the component 130 receives the prompt Pt2(X1) and generates the type Typ(i) with the large language model LLM.

### <Step S22>

In Step S22, the component 130 transmits the type Typ(i) to the component 120.

### <Step S23>

In Step S23, the component 120 receives the type Typ(i) and shares it inside the component 120.

### <Step S24>

In Step S24, the subcomponent 120B creates the prompt Pt3(X1) and transmits it to the component 130. Note that the prompt Pt3(X1) includes the instruction g3, the description DF(X1), and the document D(1).

### <Step S25>

In Step S25, the component 130 receives the prompt Pt3(X1) and identifies the reference R(1) with the large language model LLM.

### <Step S26>

In Step S26, the component 130 transmits the reference R(1) to the component 120.

### <Step S27>

In Step S27, the component 120 receives the reference R(1) and shares it inside the component 120.

### <Step S28>

In Step S28, the subcomponent 120A creates the node Nd(X1). Note that the database DB has a function of storing the knowledge graph KG.

The knowledge graph KG includes the node Nd(X1), and the node Nd(X1) includes the label LDF. The label LDF is added to a node that stores a description indicated as a fact.

The node Nd(X1) includes the label LDF, the attribute value pair AVP[DF] that can store the description DF(X1), the attribute value pair AVP[Typ] that can store the type Typ(i), the attribute value pair AVP[D] that can store information that identifies the document D(1), and the attribute value pair AVP[R] that can store information that identifies the reference R(1).

With this structure, the description DF(X1) indicated as a fact in the document D(1) can be expressed in the knowledge graph KG. For example, in the case where the document D(1) includes the description DF(X1) indicated as a fact, the type Typ(i) of the description DF(X1), information that identifies the document D(1), and information that identifies the reference R(1) of the description DF(X1) can be registered in the knowledge graph KG in association with each other. As a result, a novel information processing method that is highly convenient, useful, or reliable can be provided.

Note that this embodiment can be combined with any of the other embodiments in this specification as appropriate.

This application is based on Japanese Patent Application Serial No. 2025-022005 filed with Japan Patent Office on Feb. 14, 2025, the entire contents of which are hereby incorporated by reference.

What is claimed is:

1. An information processing system comprising:
a first component;
a second component; and
a third component,
wherein the first component is configured to:
receive a document and transmit the document to the third component; and
receive a message and provide the message,
wherein the second component is configured to:
receive a first prompt and a second prompt and transmit a description and an evaluation to the third component; and
perform processing with a large language model,
wherein the third component is configured to:
receive the document and the description and transmit the first prompt and the second prompt to the second component; and
receive the evaluation and transmit the message to the first component,
wherein the first prompt comprises a first instruction and the document,
wherein the first instruction comprises a procedure for extracting the description indicated as a fact from the document,
wherein the second prompt comprises a second instruction, the description, and public information,
wherein the second instruction comprises a procedure for generating the evaluation, and
wherein the evaluation expresses consistency between the public information and the description.

2. An information processing system comprising:
a first component;
a second component; and
a third component,
wherein the first component is configured to:
receive a first document and transmit the first document to the third component; and
receive a first message and provide the first message,
wherein the second component is configured to:
receive a first prompt and a second prompt and transmit a first description and a first evaluation to the third component; and
perform processing with a large language model,
wherein the large language model is configured to:
generate the first description in accordance with the first prompt; and
generate the first evaluation in accordance with the second prompt,
wherein the third component is configured to:
receive the first document, the first description, and the first evaluation and share the first document, the first description, and the first evaluation inside the third component;
transmit the first prompt and the second prompt to the second component; and
transmit the first message to the first component,
wherein the third component comprises a first subcomponent, a second subcomponent, and a third subcomponent,
wherein the first subcomponent is configured to:
perform processing with a database and a management system; and
obtain public information and share the public information inside the third component,
wherein the database is configured to store a public information group,
wherein the management system is configured to obtain the public information from the public information group in accordance with a first query,
wherein the second subcomponent is configured to create the first prompt, the first query, and the second prompt,
wherein the first prompt comprises a first instruction and the first document,
wherein the first instruction comprises a procedure for extracting the first description indicated as a fact from the first document,
wherein the first query comprises a request to collect information including the first description from the public information group,
wherein the second prompt comprises a second instruction, the first description, and the public information,
wherein the second instruction comprises a procedure for generating the first evaluation,
wherein the first evaluation expresses consistency between the public information and the first description, and
wherein the third subcomponent is configured to create the first message on the basis of the first evaluation.

3. The information processing system according to claim 2,
wherein the second component is configured to receive a third prompt and transmit a second evaluation to the third component,
wherein the large language model is configured to generate the second evaluation in accordance with the third prompt,
wherein the third component is configured to:
transmit a second message to the first component;
receive the second evaluation and share the second evaluation inside the third component; and
transmit the third prompt to the second component,
wherein the database is configured to store a business information group,
wherein the management system is configured to obtain business information from the business information group in accordance with a second query and share the business information inside the third component,
wherein the second subcomponent is configured to create the second query and the third prompt,
wherein the second query comprises a request to collect information including the first description from the business information group,
wherein the third prompt comprises a third instruction, the first description, and the business information,
wherein the third instruction comprises a procedure for generating the second evaluation,
wherein the second evaluation expresses consistency between the business information and the first description, and
wherein the third subcomponent is configured to create the second message on the basis of the second evaluation.

4. The information processing system according to claim 3,
wherein, when the first evaluation is lower than a set evaluation and the second evaluation is higher than the set evaluation, the second message reports that the first description includes information that is not included in the public information group but included in the business information group.

5. The information processing system according to claim 2,
wherein the second component is configured to receive a fourth prompt and transmit a type to the third component,
wherein the large language model is configured to classify the first description into the type in accordance with the fourth prompt,
wherein the third component is configured to:
transmit the fourth prompt to the second component; and
receive the type and share the type inside the third component,
wherein the second subcomponent is configured to create the fourth prompt,
wherein the fourth prompt comprises a fourth instruction and the first description, and
wherein the fourth instruction comprises a procedure for classifying the first description into the type.

6. The information processing system according to claim 5,
wherein the second component is configured to receive a fifth prompt and transmit a first reference to the third component,
wherein the large language model is configured to identify the first reference in accordance with the fifth prompt,
wherein the third component is configured to:
transmit the fifth prompt to the second component; and
receive the first reference and share the first reference inside the third component,
wherein the second subcomponent is configured to create the fifth prompt,
wherein the fifth prompt comprises a fifth instruction, the first description, and the first document, and
wherein the fifth instruction comprises a procedure for extracting the first reference of the first description from the first document.

7. The information processing system according to claim 6,
wherein the database is configured to store a knowledge graph,
wherein the knowledge graph comprises a first node and a second node,
wherein the first subcomponent is configured to create the first node and the second node,
wherein each of the first node and the second node comprises a first label,
wherein the first label is added to a node storing a description indicated as a fact,
wherein the first node comprises:
a first attribute value pair configured to store a second description;
a second attribute value pair configured to store the type;
a third attribute value pair configured to store information that identifies a second document; and
a fourth attribute value pair configured to store information that identifies a second reference,
wherein the second description is a description indicated as a fact in the second document included in the public information group,
wherein the second reference is a reference of the second description included in the second document, and
wherein the second node comprises:
the first label;
the first attribute value pair configured to store the first description;
the second attribute value pair configured to store the type;
the third attribute value pair configured to store information that identifies the first document; and
the fourth attribute value pair configured to store information that identifies the first reference.

8. The information processing system according to claim 7,
wherein the first component is configured to receive a third node from the third component and provide the third node,
wherein the management system is configured to obtain the third node from the knowledge graph in accordance with a third query and share the third node inside the third component,
wherein the second subcomponent is configured to create the third query, and
wherein the third query comprises:
a request to collect a node classified into the type from the knowledge graph and create a result set; and
a request to collect, from the result set, the third node in which the fourth attribute value pair does not store information that identifies a document in the result set.

9. The information processing system according to claim 8,
wherein the first component is configured to receive a hearsay path from the third component and provide the hearsay path,
wherein the hearsay path comprises a chain which comprises a source node and a destination node and starts from the third node,
wherein the management system is configured to obtain the hearsay path from the knowledge graph in accordance with a fourth query and share the hearsay path inside the third component,
wherein the second subcomponent is configured to create the fourth query,
wherein the fourth query comprises a request to collect the chain from the result set, and
wherein the fourth attribute value pair of the destination node stores information that identifies a document stored in the third attribute value pair of the source node.

10. The information processing system according to claim 7,
wherein the large language model is configured to generate a third description in accordance with the first prompt,
wherein the first instruction comprises a procedure for extracting the third description expressed as an opinion or a comment from the first document,
wherein the knowledge graph comprises a third node,
wherein the first subcomponent is configured to create the third node,
wherein the third node comprises a second label,
wherein the second label is added to a node storing a description expressed as an opinion or a comment, and
wherein the third node comprises:
a fifth attribute value pair configured to store the third description;
the second attribute value pair configured to store the type; and
the third attribute value pair configured to store information that identifies the first document.

11. The information processing system according to claim 10,
wherein the first component is configured to receive a fourth node from the third component and provide the fourth node,
wherein the management system is configured to obtain the fourth node from the knowledge graph in accordance with a third query and share the fourth node inside the third component,
wherein the second subcomponent is configured to create the third query,
wherein the third query comprises:
a request to collect a node classified into the type from the knowledge graph and create a result set; and
a request to collect the fourth node from the result set,
wherein the fourth node comprises the first label, and
wherein information stored in the third attribute value pair of the third node including the second label is stored in the fourth attribute value pair.

12. An information processing method comprising:
a first step, a second step, a third step, a fourth step, a fifth step, a sixth step, a seventh step, an eighth step, a ninth step, a tenth step, an eleventh step, a twelfth step, a thirteenth step, a fourteenth step, a fifteenth step, and a sixteenth step;,
wherein in the first step, a first component receives a document and transmits the document to a second component comprising a first subcomponent configured to perform processing with a database and a management system, a second subcomponent configured to create a first prompt comprising a first instruction and the document, and a third subcomponent,
wherein in the second step, the second component receives the document and transmits the first prompt to a third component,
wherein the database is configured to store a public information group and a business information group,
wherein the first instruction comprises a procedure for extracting a description indicated as a fact from the document,
wherein in the third step, the third component receives the first prompt and generates the description with a large language model,
wherein in the fourth step, the third component transmits the description to the second component,
wherein in the fifth step, the second subcomponent creates a first query comprising a request to collect information including the description from the public information group and shares the first query inside the second component,
wherein in the sixth step, the first subcomponent obtains public information from the database in accordance with the first query with the management system and shares the public information inside the second component,
wherein in the seventh step, the second subcomponent creates a second prompt comprising a second instruction, the description, and the public information and transmits the second prompt to the third component,
wherein the second instruction comprises a procedure for generating a first evaluation expressing consistency between the public information and the description,
wherein in the eighth step, the third component receives the second prompt and generates the first evaluation with the large language model,
wherein in the ninth step, the second component receives the first evaluation from the third component and shares the first evaluation inside the second component,
wherein in the tenth step, the second subcomponent creates a second query comprising a request to collect information including the description from the business information group and shares the second query inside the second component,
wherein in the eleventh step, the first subcomponent obtains business information from the database in accordance with the second query with the management system and shares the business information inside the second component,
wherein in the twelfth step, the second subcomponent creates a third prompt comprising a third instruction comprising a procedure for generating a second evaluation, the description, and the business information and transmits the third prompt to the third component,
wherein the second evaluation expresses consistency between the business information and the description,
wherein in the thirteenth step, the third component receives the third prompt and generates the second evaluation with the large language model,
wherein in the fourteenth step, the second component receives the second evaluation from the third component and shares the second evaluation inside the second component,
wherein in the fifteenth step, the third subcomponent creates a message on the basis of the first evaluation and the second evaluation and transmits the message to the first component,
wherein when the first evaluation is lower than a set evaluation and the second evaluation is higher than the set evaluation, the message reports that the description includes information that is not included in the public information group but included in the business information group, and
wherein in the sixteenth step, the first component receives the message and provides the message.

13. The information processing method according to claim 12, further comprising a seventeenth step, an eighteenth step, a nineteenth step, a twentieth step, a twenty-first step, a twenty-second step, and a twenty-third step,
wherein in the seventeenth step, the second subcomponent creates a fourth prompt comprising a fourth instruction and the description and transmits the fourth prompt to the third component,
wherein the fourth instruction comprises a procedure for classifying the description into a type,
wherein in the eighteenth step, the third component receives the fourth prompt and generates the type with the large language model,
wherein in the nineteenth step, the second component receives the type from the third component and shares the type inside the second component,
wherein in the twentieth step, the second component creates a fifth prompt comprising a fifth instruction comprising a procedure for extracting a reference of the description from the document, the description, and the document and transmits the fifth prompt to the third component,
wherein in the twenty-first step, the third component receives the fifth prompt and identifies the reference with the large language model,
wherein in the twenty-second step, the second component receives the reference from the third component and shares the reference inside the second component,
wherein in the twenty-third step, the first subcomponent creates a node,
wherein the database is configured to store a knowledge graph comprising the node,
wherein the node comprises a label,
wherein the label is added to a node storing a description indicated as a fact, and
wherein the node comprises:
the label;
a first attribute value pair configured to store the description;
a second attribute value pair configured to store the type;
a third attribute value pair configured to store information that identifies the document; and
a fourth attribute value pair configured to store information that identifies the reference.
